(19) United States
(12) Patent Application Publication
(10) Pub. No.: US 2001/0007416 A1
(43) Pub. Date: Jul. 12, 2001

(54) Device and method for determining step-out of synchronous motor

(76) Inventors: Satoshi Koide, Okazaki-shi (JP); Yasutomo Kawabata, Aichi-gun (JP); Eiji Yamada, Owariasahi-shi (JP)

Correspondence Address: KENYON & KENYON, One Broadway, New York, NY, 10004, US

(21) Appl. No.: 09/753,458

(22) Filed: Jan. 4, 2001

(30) Foreign Application Priority Data
Jan. 12, 2000 (JP) 2000-003160

(51) Int. Cl. H02P 1/46; H02P 3/18; H02P 5/28; H02P 7/36

(52) U.S. Cl. 318/701

(57) ABSTRACT

The expected power to be output from a synchronous motor is obtained based on a torque command value and revolution speed of the motor. Meanwhile electric power consumption is detected based on voltage and current actually applied to the motor. If a parameter derived from a deviation or a ratio of the two exceeds a predetermined threshold value, it is determined that step-out has occurred. When using the deviation of the expected power from the electric power consumption as the parameter, the threshold value is determined in relation to the torque command value and the revolution speed. When using the ratio of the expected power and the electric power consumption as the parameter, the threshold value is set in relation to the revolution speed. This enables step-out to be accurately determined with an extremely light computational load.

### INCORPORATION BY REFERENCE

The disclosure of Japanese Patent Application No. 2000-003160 filed on Jan. 12, 2000 including the specification, drawings and abstract is incorporated herein by reference in its entirety.

### BACKGROUND OF THE INVENTION

1. Field of the Invention

The invention relates to art for detecting step-out of a synchronous motor during operation.

2. Description of Related Art

In order to obtain desired torque with a synchronous motor, which is one of the AC motors, the multiphase alternating current supplied to the coil in accordance with the position of the rotor, or the electrical angle, needs to be controlled. If the detection error of the electrical angle becomes larger and the direction in which voltage is applied deviates from the proper direction, desired torque cannot be obtained by the synchronous motor. If the deviation further increases, the multi-phase alternating current becomes uncontrollable, leading to what is called a step-out state. When step-out occurs, processing, such as resetting of the control processing must be executed to restart operation.

Proposed detection methods for step-out include a detection method using counter-electromotive voltage generated during rotation of the motor, and a method wherein the determination of the presence/absence of step-out is made by a combination of the effective value of current running through the coil and the power factor angle, that is, the difference between the phase of the applied voltage and the phase of the current (for example, the art disclosed in Japanese Patent Application Laid-Open No. HEI 9-294390).

However, in art which uses counter-electromotive voltage generated during rotation of the rotor, there were cases where step-out was not able to be accurately detected when the motor was running at high speed or when it is stopped. Also, with the art using a combination of the effective value of current running through the coil and the power factor degree, extremely complex computation of effective value and power factor degree was necessary, which placed a heavy load on the motor control unit. Recently, art in which the synchronous motor is controlled by detecting the electrical angle without a sensor is also proposed. In such case, because the control unit has to bear the computational load in detecting the electrical angle, the load for detecting step-out is too large to ignore.

### SUMMARY OF THE INVENTION

It is an object of the invention to provide art that enables the detection of whether or not step-out has occurred in a synchronous motor over a wide range of operation state with a light computational load.

In a first aspect of the invention, a step-out detection device detects step-out in controlling driving of a synchronous motor by detecting an electrical angle and supplying multi-phase alternating current to a coil in accordance with the electrical angle. The synchronous motor is provided with predicted value specifying device that obtains a predicted value of at least either the energy input to or the energy output from the synchronous motor per unit time, electric power consumption detector that detects electric power consumed by the synchronous motor, and step-out determination device that determines whether or not step-out has occurred in the synchronous motor by comparing a relative size of a predetermined parameter derived from the deviation of the predicted value from the detected electric power with a predetermined threshold value in accordance with an operation state of the synchronous motor.

In a second aspect of the invention, a step-out detection device comprises the synchronous motor provided with predicted value specifying device that obtains a predicted value of at least either the energy input to or the energy output from the synchronous motor per unit time, electric power consumption detector that detects electric power consumed by the synchronous motor, and step-out determination device that determines whether or not step-out has occurred in the synchronous motor by comparing a relative size of a predetermined parameter derived from the ratio of the predicted value and the detected electric power with a predetermined threshold value in accordance with the revolution speed of the synchronous motor.

The basic concept of the invention is to determine the presence/absence of step-out in controlling a synchronous motor based on the difference between the energy that should be input to or the energy that should be output from the synchronous motor and the energy that is actually input to or output from the synchronous motor. Since it is an ordinary practice in control processing to make such determination according to the energy per unit time, in this specification, the term energy referred to herein shall mean the energy that is input to or output from the motor per unit time. In that sense, the term energy is synonymous with the terms, work rate, driving power, and electric power.

During normal operation, only a slight difference exists between the energy that should be either input or output (hereinafter referred to as “predicted energy”) and the detected value of energy that is actually input or output (hereinafter referred to as “detected energy”) originating in heat loss, control delay, and detection error of electrical angle. On the other hand, if there is step-out, the difference is clearly discriminable compared to the case with normal operation. Accordingly, the presence/absence of step-out can be detected by evaluating the difference between the predicted energy and the detected energy based on a predetermined reference. Since both the predicted energy and the detected energy are obtained by multiplying the torque, revolution speed, voltage, and electric current, the computational load is very low. Therefore, according to the invention it is possible to detect step-out with a light load.

The energy input to or output from the motor can be roughly divided into mechanical energy or power, and electrical energy or electric power. Although it is possible to use mechanical energy, in the invention, electric power consumed by the motor is used as the detected energy in the step-out detection device. Since electric power consumption is detectable during ordinary motor control with necessary sensors there is an advantage that new hardware is unnecessary.

For determining the difference between the predicted energy and the detected energy, a parameter including the deviation between the two are used in a first configuration, and a parameter including the ratio of the two are used in a second configuration. The parameters used may be obtained by multiplying the deviation or the ratio of the two with a predetermined coefficient, or set as a function including the deviation between the two or the ratio of the two.

With the invention, it is determined whether or not step-out has occurred based on the relative size of these parameters and a predetermined value. In the first configuration, determination of the relative size is made in accordance with the operation state of the synchronous motor whereas in the second configuration, the determination is made in accordance with the revolution speed of the synchronous motor. In the first configuration, determination of the relative size may be made in accordance with the torque command value and the revolution speed of the synchronous motor. The term “in accordance with” encompasses both a aspect wherein the parameter itself is corrected based on the torque command value and the revolution speed before comparing it with a predetermined threshold value, and a aspect wherein a predetermined threshold value is set in relation to the torque command and the revolution speed.

In an effort to accomplish this invention, the inventors of the invention investigated in detail the relationship between the above-mentioned parameters and step-out. As a result, we discovered a phenomenon in which, when a parameter including the deviation of the predicted energy from the detected energy is used, this parameter value fluctuates according to the torque command value and the revolution speed, an effect that has never before been reported. The first aspect is realized from this aspect, and the presence/absence of step-out is accurately determined by comparing the parameter value with the predetermined threshold value in accordance with the torque command value and revolution speed.

Similarly, another phenomenon we discovered, which had also never been reported before, is that when a parameter including the ratio of the predicted energy and the detected energy is used, this parameter value is substantially unaffected by the torque command value, despite fluctuation by revolution speed. The second aspect is realized from this aspect, and the presence/absence of step-out is accurately determined by comparing the parameter with a predetermined threshold value in accordance with the revolution speed. According to the second aspect, there is an advantage that the torque command value can be disregarded.

As mentioned earlier, since both mechanical energy and electrical energy can be used as the predicted energy, in the step-out detection device of the invention the predicted value specifying device may be means for obtaining mechanical power input to or output from the synchronous motor based on the torque command value and the revolution speed of the synchronous motor, or means for obtaining a predicted value of electric power consumed by the synchronous motor when the electrical angle is a true value based on the torque command value and the revolution speed of the synchronous motor.

Since the torque command value and the revolution speed are values always input upon controlling of the synchronous motor, the former aspect has an advantage that the predicted energy can be immediately obtained using this value. In the latter aspect, there is a need to reference a table, a function, or the like to obtain the electric power consumed in realizing operation under the torque command value and the revolution speed. However, since it is ordinary practice in motor control to reference tables in setting the electric current to be supplied to each phase of the motor according to the torque command value, if the electric power consumption were determined together with this, there is an advantage that it can be obtained with a relatively light load. Also, torque can be acted on the rotor even when the synchronous motor is stopped. Accordingly, in this case, determination of step-out becomes difficult because the mechanical power becomes 0 in the former aspect, but in the latter aspect, there is an advantage that the detection of step-out can be accurately implemented without such difficulty.

The step-out detection of the invention may be applied when controlling the motor operation while detecting the electrical angle with a hall element or the like, but it may be more effectively applied when the electrical angle is detected without a sensor. This is because error tends to occur in the detected value of the electrical angle when operation is controlled according to the detected value of the electrical angle without a sensor, thereby leading to step-out. Also, the detection method for detecting the electrical angle without a sensor which is applied when the synchronous motor is running such that the electrical angle can be consistently detected when the error is generally within a predetermined range. Therefore it becomes very difficult to restore the motor to a normal state of operation with the detected value of the electrical angle once the detection error becomes large and step-out occurs. Further, because determination of step-out can be made with a very light load with the step-out detection device of the invention, there is an advantage that an excessive load can be prevented from being applied to the control unit even with the sensorless control which has a considerable processing load during detection of the electrical angle.

Above, an explanation has been given for a case where the invention is configured as a step-out detection device. The invention is not limited to such aspects, and it may be configured in various other aspects. For example, it may be configured as a motor control unit with the above-mentioned step-out detection device built in, or it may be configured as a vehicle or a device for industrial machinery to which the motor control unit and the motor is applied. The invention may be in the form of step-out detection method, motor control method, and the like.

In these aspects, there may be provided responding means for returning the motor operation to an ordinary state when step-out is detected. The responding means may be configured as means for restoring a normal state by resetting the operation control processing of the motor and restarting operation. Further, the responding means may be configured as a aspect for providing means for informing an operator of a device equipped with the motor of generation of step-out to urge the operator to restore the motor to an ordinary state of operation. Accordingly, the responding means may take various configurations for urging a control portion that is located at a higher hierarchical level than the step-out detection device in terms of motor control to restore the motor to a normal operation state.

### BRIEF DESCRIPTION OF THE DRAWINGS

FIG. 1 is an explanatory drawing showing a schematic configuration of a motor control unit according to one embodiment of the invention.

FIG. 2 is an explanatory drawing showing an equivalent circuit of a three-phase synchronous motor.

FIG. 3 is a flowchart of a motor control processing routine.

FIG. 4 is a flowchart of an electrical angle detection processing routine.

FIG. 5 is a flowchart of a current control processing routine.

FIG. 6 is a flowchart of a step-out determination processing routine.

FIG. 7 is a graph showing a relationship between a parameter “Pe−Pm” and a detection error of the electrical angle.

FIG. 8 is a graph showing a relationship between a parameter “Pe/Pm” and a detection error of the electrical angle.

FIG. 9 is a flowchart of a step-out determination processing routine according to a second embodiment.

FIG. 10 is a graph showing a relationship between a parameter “Pe−P0” and a detection error of the electrical angle.

FIG. 11 is a graph showing a relationship between a parameter “Pe/P0” and a detection error of the electrical angle.

### DETAILED DESCRIPTION OF THE PREFERRED EMBODIMENTS

The aspects for embodying the invention will be described in the following order based on the embodiments. First, a configuration and control processing of a motor control unit subject to setting of a control gain will be described. Then, a method for setting the control gain will be described.

A: Configuration of the unit;

B: Motor control processing;

C: Electrical angle detection processing;

D: Current control processing;

E: Step-out determination processing;

F: Modified example of the first embodiment;

G: Second embodiment; and

H: Modified example of the second embodiment.

A: Configuration of the Unit;

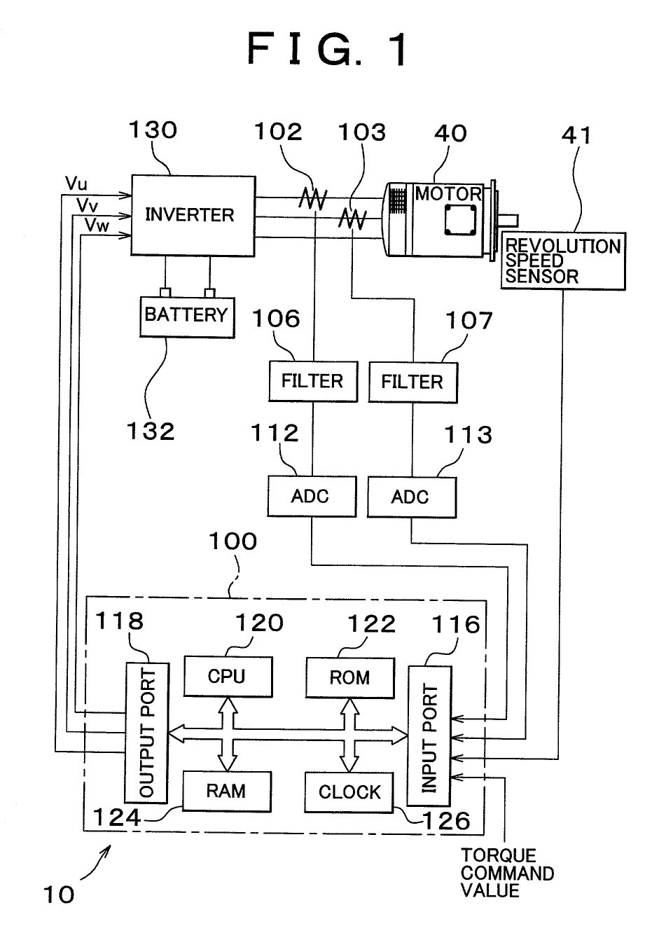

FIG. 1 is an explanatory drawing showing a schematic configuration of a motor control unit 10 as an embodiment. A step-out detection device uses hardware of the motor control unit 10 and is configured as a function of the motor control unit. Various synchronous motors are applicable to a motor 40, which is the subject of control. In this embodiment, a three-phase synchronous motor of a salient pole type with permanent magnet attached to a rotor is used. The motor control unit 10 controls the operation of the motor 40 by controlling the electric current that flows through U, V, and W phases thereof from a battery 132, a power source, by switching a transistor inverter 130. In the control of this embodiment, a sensor for detecting an electrical angle of the rotor is not provided, but instead, the electrical angle is calculated without a sensor.

The motor control unit 10 is provided with a control unit 100, electric current sensors 102 and 103 for detecting a U-phase current iu and a V-phase current iv of the three-phase synchronous motor 40, filters 106 and 107 for removing high frequency noise of the detected current, and two analog-digital converters (ADC) 112 and 113 for converting the detected current value into digital data. The motor control unit 10 detects the current running in each phase using these elements. There is no current sensor, filter, or ADC provided for a W-phase, because in the case of a three-phase alternating current, a sum of the current for the U, V, and W phases is constantly maintained at 0. Accordingly, a current iw of the W-phase can be calculated from the current values for the U and V phases. Further, a revolution speed sensor 41 for detecting a revolution speed of the motor 40 is provided, and the detected number of revolutions is input to the control unit 100.

Inside the control unit 100, as shown in the figure, a CPU 120 for executing arithmetic and logic operation, ROM 122 in which is previously stored necessary data for processing executed by the CPU 120, RAM 124 for temporarily reading and writing data or the like necessary for processing, a clock 126 for clocking, and the like are provided, and are connected to each other via a bus. An input port 116 and output port 118 are also connected to this bus. The CPU 120 reads the electric current iu and iv flowing through each of the U and V phases of the three-phase synchronous motor through these input ports. Also, a torque command value is input to the control unit 100 separately.

Control outputs Vu, Vv, and Vw for implementing what is called PWM control of each transistor provided for the U, V, and W phases of a transistor inverter 130 are output from the output ports 118 of the control unit 100. When each transistor is turned ON/OFF in accordance with the control output, an pseudo sine wave alternating current flows through the coils of the U, V, and W phases, which then generates a rotating magnetic field, rotating the motor 40 thereby.

B: Motor Control Processing;

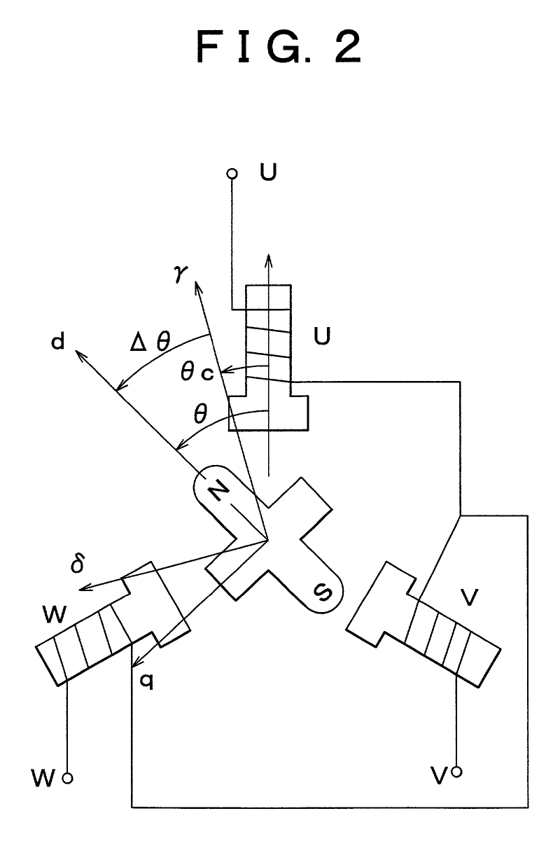

Next, the motor control processing in this embodiment will be described. FIG. 2 shows an equivalent circuit of the three-phase synchronous motor 40. The three-phase synchronous motor 40 is, as shown in the figure, represented by three-phase coils for U, V, and W phases and a rotor having a permanent magnet. In this equivalent circuit, an axis passing through the permanent magnet in the direction of the N-pole side is called a d-axis, and an axis orthogonal to the d-axis is called a q-axis. Accordingly, the electrical angle is an angle θ formed by an axis passing through the U-phase coil and the d-axis.

When implementing vector control of the operation of the motor 40, electric current values to be applied in the d-axis direction and the q-axis direction are determined according to the requested torque. To realize such current, current flowing through each phase needs to be changed according to the electrical angle. However, when controlling the motor 40 without a sensor, the electrical angle θ is unknown to the control unit 100. Therefore, a current electrical angle θ is estimated by the control unit 100 based on a previous electrical angle and the revolution speed of the motor 40 to apply voltage thereby. Further, an error Δθ of the electrical angle is corrected by the control unit 100 from a predetermined operation expression using the electric current value flowing through each phase according to the voltage so as to detect a true value θ. Current flowing in each phase is controlled based on the thus detected electrical angle θ. When the motor is operating normally, the error of the electrical angle is relatively small so that it is possible to drive the motor 40 stably with the above-mentioned processing. However, if the detection error of the electrical angle becomes extremely large for some reason, the above-mentioned control cannot be conducted stably, thus making it impossible to control the operation of the motor 40. Such a state is called step-out. The motor control unit 10 of the invention determines whether or not there is step-out in addition to performing drive control of the motor 40, thus enabling measures to be taken therefor. The motor control according to this embodiment is realized as shown by a flowchart described below.

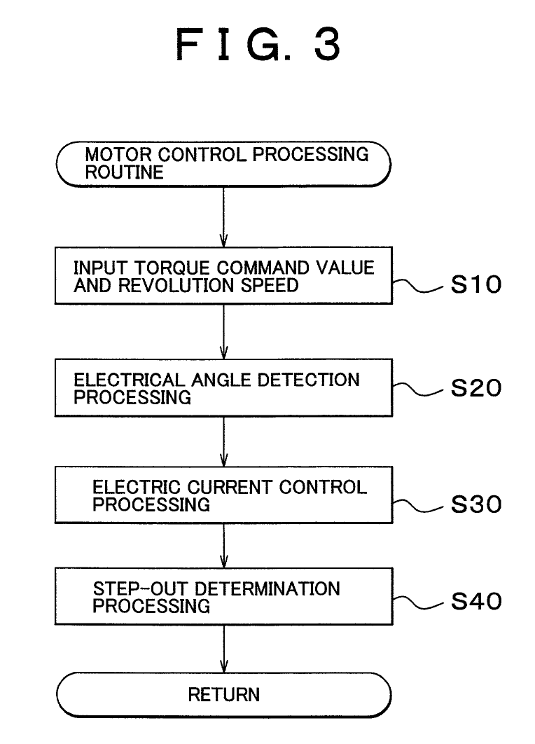

FIG. 3 is a flowchart of a motor control processing routine. The CPU 120 of the control unit 100 repeats this process. In this process, the torque command value and the revolution speed of the motor 40 are first input, and electrical angle detection processing is conducted to detect the electric angle of the motor 40 (steps S10 and S20). Then, an electric current control processing for applying current for outputting the requested torque in accordance with the detected electrical angle (step S30) is conducted. Lastly, step-out determination processing for determining presence/absence of step-out is conducted (step S40). Further, although the example of FIG. 3 dealt with a case where the step-out determination processing is conducted each time the motor control processing routine is executed, the step-out determination processing may also be conducted after this routine is executed for several times. Hereafter, each routine will be described.

C: Electrical Angle Detection Processing;

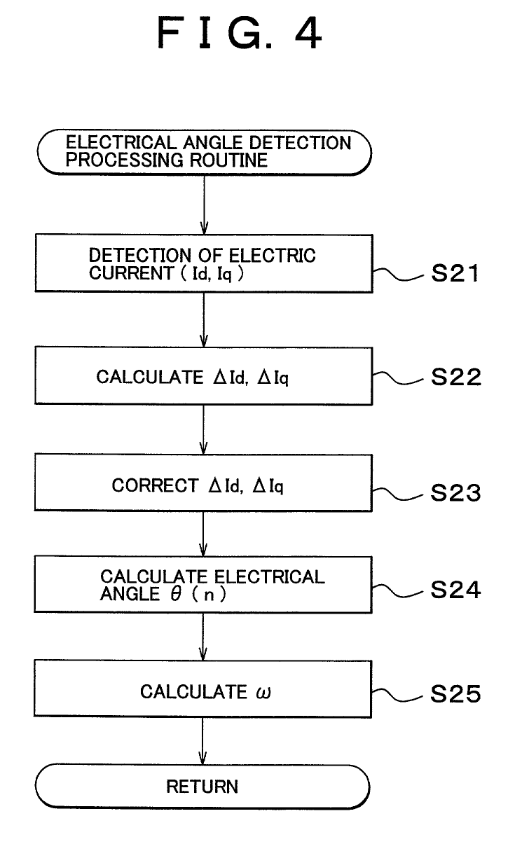

FIG. 4 is a flowchart of an electrical angle detection processing routine. In this embodiment, a method capable of detecting the electrical load with a light operational load and good accuracy was used. That is, the method was such that the electrical angle is detected from an operation expression using a single parameter including at least a deviation of the actually detected d-axis current value from a model value of the d-axis current which is obtained based on a voltage equation for the coil of the motor 40.

The electrical angle detection processing is conducted by the following procedures. At the start of this process, a certain model value θc is estimated by the CPU 120 as the electrical angle based on control which had been conducted up to that point (see FIG. 2). Also, electric current corresponding to the requested torque is running through each coil of the motor 40 according to the control which had been conducted up to that point. The CPU 120 detects a current Id of the d-axis as well as a current Iq of the q-axis (step 21). These currents are obtained by implementing three-phase/two-phase conversion of the electric current values of the U phase and the V phase detected by the electric current sensors 102 and 103 shown in FIG. 1.

Using the electric current values Id and Iq thus detected, ΔId and ΔIq are calculated using the formulas (1) through (4) below (step S22).

ΔId=Id(n)−Idm (1);

Idm=Id(n−1)+Idm=Id(n−1)+t{Vd−R·Id(n−1)+ω·Lq·Iq(n−1)}/Ld (2);

ΔIq=Iq(n)−Iqm (3);

Iqm=Iq(n−1)+t{Vq−R·Iq(n−1)−ω·Ld·Id(n−1)−E(n−1)}/Lq (4);

Here, each variable means the following.

Id(n) is a value of magnetizing current at the present time;

Idm is a model value of the magnetizing current;

Id(n−1) is a value of the magnetizing current at the previous time;

Iq(n) is a value of torque current at the present time;

Iqm is a model value of the torque current;

Iq(n−1) is a value of the torque current at the previous time;

Ld is an inductance in the direction of the magnetizing current;

Lq is an inductance in the direction of the torque current;

R is a resistance value of the coil;

E is an electromotive force generated at the coil;

Vd is a voltage value in the direction of the magnetizing current;

Vq is a voltage value in the direction of the torque current;

t is a cycle of operation execution;

ω is a rotational angular velocity of the motor [rad/sec];

Next, ΔId and ΔIq are corrected by the CPU 120 (step S23). In this embodiment, the relationship between the requested torque and the correction amount is stored in the ROM 122 as a table, and the correction amounts for ΔId and ΔIq are determined by referencing this table. This correction is for compensating for the deviation of the error ΔId and ΔIq of the current from the equations (1) through (4) due to magnetic flux saturation generated at the coil of the motor 40 when the requested torque is large. The correction amount is set experimentally according to the requested torque such that the electrical angles Id and Iq are 0 when the error is 0. If the current running through the coil is relatively small, correction may be omitted. As will be described later, in this embodiment, since the electrical angle is calculated using a parameter “ΔId+ΔIq”, the correction table may be provided for “ΔId+ΔIq” in accordance with this parameter. Further, the correction table may be provided in the form of “α·Id+β·ΔIq (α and β are coefficients).”

Using the thus obtained ΔId and ΔIq, an electrical angle θ (n) is obtained with the following equations (5) and (6) (step S24), and ω is calculated from the equation (7) (step S25). The electrical angle θ (n) and the angular velocity ω thus calculated are used for the control processing at a subsequent time.

θ=θ(n−1)+Kp·PM+Ki·ΣPM (5);

PM=α·ΔId+β·ΔIq (6);

ω=(Kp·PM+Ki·ΣPM)/t (7);

That is, the electrical angle θ is calculated by a proportional integral control having a polynomial of ΔId and ΔIq as one of its parameters. Further, α and β are random real numbers, and in this embodiment, α=β=1. Kp and Ki are control gains, which may be set to appropriate values experimentally or analytically.

According to this processing, the electrical angle can be detected by a proportional integration equation using a single parameter PM, and therefore, processing can be conducted at a high speed. It is further recognized that it is possible to detect the electrical angle with extremely high accuracy depending on the setting of the control gains Kp and Ki. Further, there are many other known methods for detecting the electrical angle without a sensor, any of which may be applied. For example, a method wherein the electrical angle is detected using an operation expression with time difference substituted for the differential term in the voltage equation may be adopted.

D: Current Control Processing;

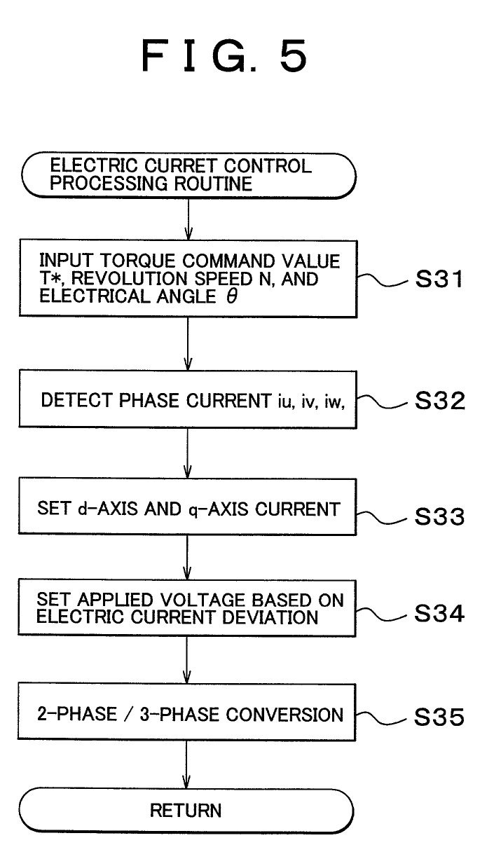

FIG. 5 is a flowchart of a current control processing routine. This is processing for controlling the current running through each phase according to a torque command value T* and revolution speed N. In this process, first, the torque command value T*, the revolution speed N and the electrical angle q are input by the CPU 120 (step S31). Then, the currents iu, iv, iw of the respective phases are detected (step S32). Electric current running in the directions of the d-axis and the q-axis may be obtained by conducting three-phase/two-phase conversion of the detected current of each phase. The electrical angle θ is used for this three-phase/two-phase conversion. Next, the d-axis current and the q-axis current for realizing the operation state are set based on the torque command value T* and the revolution speed N (step S33). The correspondence between the torque command value and the revolution speed with the d-axis current and the q-axis current are prepared in advance in the form of a two dimensional table. This table is referenced when setting the d-axis current and the q-axis current. After the current to be applied in each axis direction is set, the applied voltage is set based on the deviation of the detected d-axis current and the q-axis current from the set values (step S34). Although there are various possible methods for setting the applied voltage, here, it was set using proportional integral control based on the deviation. The control may also be an open-loop control wherein the d-axis voltage and the q-axis voltage are given by a two dimensional table of the torque command value T* and the revolution speed N. After the applied voltage in the d-axis and the q-axis directions are set by these methods, it is converted by the CPU 120 to voltage to be applied to the respective phases by two-phase/three-phase conversion, and signals for controlling switching of the inverter are generated so as to realize this voltage (step S35).

E: Step-out Determination Processing;

The idea of step-out determination in this embodiment is as described hereafter. When the detection error of the electrical angle is small, the voltage as set should be applied to the d-axis and the q-axis in current control, and the set current should run therethrough. As a result, the motor 40 runs in a state in accordance with the torque command value and the revolution speed. That is, a mechanical power represented by “torque command value·revolution speed” should be output from the motor 40. At this time, the difference between the electric power consumed by the motor 40 and the power to be output from the motor 40 (hereafter called expected power) is kept within a relatively small range comparable with loss incurred by slight error originating from electrical angle detection error or control delay, or loss incurred by generation of heat.

On the other hand, if there is step-out, the detection error of the electrical angle becomes significantly large so that a voltage as set is no longer applied to the d-axis and the q-axis electric current control. This is because the d-axis and the q-axis rotate in accordance with the electrical angle, and the directions the control unit 100 believes to be the d-axis and q-axis directions greatly deviate from the actual d-axis and q-axis directions, when the detection error of the electrical angle is large. As a result, not only does the current running through each phase differ from the proper current, but the electric power consumed differs greatly from that during a normal state due to a great difference in the amount of work done by the magnetic field generated by power application as compared to that during a normal state. Such a relationship exists even when the motor 40 is under regenerative operation. During regenerative operation, since the torque command value T* becomes negative, the expected power also becomes negative. On the other hand, power consumption becomes negative because electric power is generated by the motor 40. Accordingly, the above-mentioned relationship exists with both values being negative.

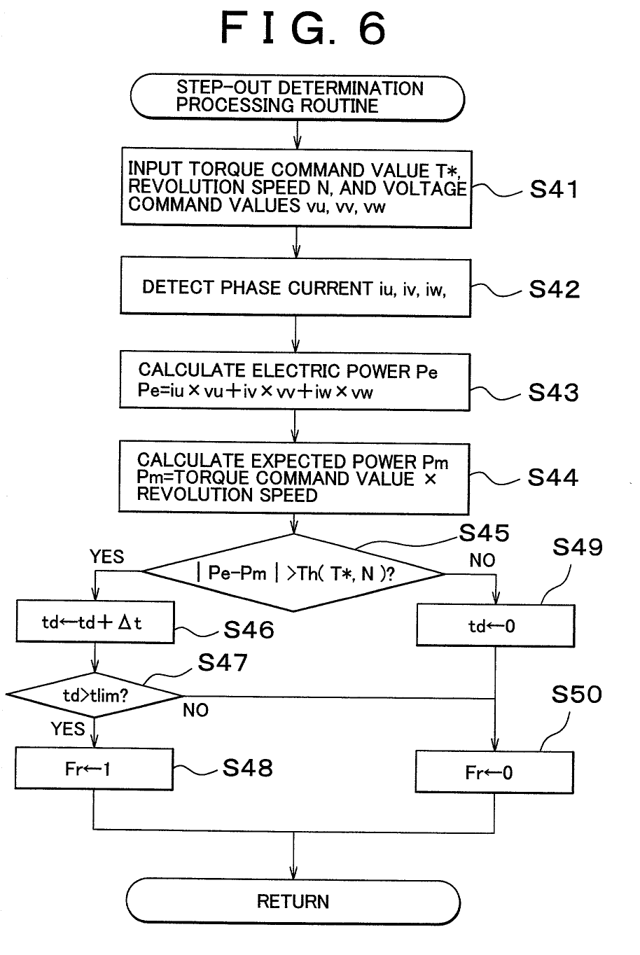

The step-out determination in this embodiment uses this characteristic, and determines the presence/absence of step-out based on the expected power and the actually consumed electric power of the motor 40. The step-out determination is embodied by the following processing. FIG. 6 is a flowchart showing the step-out determination processing routine. In this process, the CPU inputs the torque command value T*, the revolution speed N, and voltage command values vu, vv, vw (step S41). Next, the currents iu, iv, and iw [A] of the respective phases are detected by the current sensors 102 and 103, and the power consumption Pe[w] is calculated from the sum of the product of the voltage command value and the current value for the respective phases (steps S42, S43). That is, Pe=iu·vu+iv·vv+iw·vw.

Next, the expected power Pm is calculated from the product of the torque command value and the revolution speed (step S44). Here, the expected power Pm is calculated using the same unit as the electric power Pe. In this embodiment, the expected power Pm was calculated with the torque command value [N·m] and revolution speed [rad/sec].

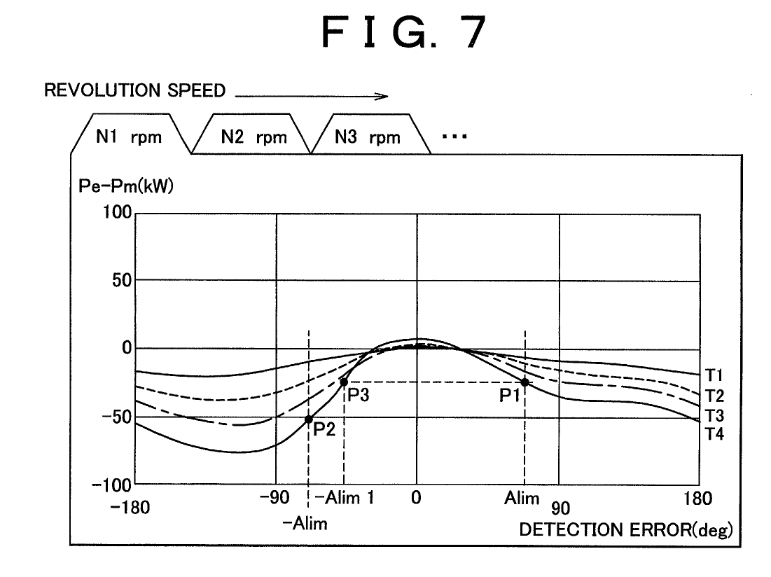

Using the absolute value of the difference between the calculated electric power Pe and the expected power Pm as the parameter, it is determined whether or not this parameter is larger than a predetermined threshold value Th (step S45). Now, the relationship between the parameter and the threshold value Th will be described. FIG. 7 is a graph showing the relationship between “Pe−Pm” and the detection error of the electrical angle. It is a result from an experiment conducted by the inventors of the invention using a synchronous motor. Here, results for four stages of torque command values T1, T2, T3, and T4 for a revolution speed N1 [rpm] are exemplified. The torque command values become larger in the order of T1, T2, T3, and T4. When the detection error of the electrical angle is near 0, that is, during normal operation, as explained earlier, the deviation between the electric power Pe and the expected power Pm is substantially near 0. However, it can be seen that the absolute value of the deviation increases as the detection error of the electrical angle increases. When the detection error becomes extremely large, control becomes very unstable, which leads to step-out.

The detection error which serves as a reference for determining step-out can be randomly set according to the model or the control accuracy required by the electrical angle detection processing or the current control processing. In this embodiment, a determination reference Alim for step-out was set to a value slightly smaller than absolute value of 90 degrees of the detection error. Accordingly, the threshold value Th used in step S45 should be the deviation corresponding to this determination reference Alim. As shown in the figure, the value corresponding to the detection error “Alim” for the torque command value T4 is a deviation at point P1. A value corresponding to a detection error “−Alim” is the deviation at point P2. In this embodiment, because the values do not coincide, the threshold value was set to the safe side. That is, the value corresponding to point P1 with a smaller absolute value of deviation was used as the threshold value Th. As a result, if detection error occurs on the negative side, it will be determined as step-out at the time the detection error occurs on the negative side with respect to the detection error “−Alim1”.

As apparent from the experiment results in FIG. 7, the relationship between the detection error which serves as a reference for determining step-out and the deviation corresponding thereto fluctuates in accordance with the torque command value. Therefore, in this embodiment, the threshold value Th used in step S45 was set for each torque command value. The experiment results shown in FIG. 7 are those for a certain revolution speed N1 [rpm]. Accordingly, different results are obtained for revolution speeds N2 and N3 due to differences in electromotive forces and the like. Consequently, in this embodiment, different values were set as the threshold value Th used in step S45 according to the revolution speed. Actually, the threshold value Th was stored in the form of a two dimensional table according to the torque command value and the revolution speed, and this two dimensional table was interpolated depending on the torque command value T* and the revolution speed N to obtain the threshold value (T*, N) in step S45.

Referring back to FIG. 6, the step-out determination processing will continue to be described. In step S45, if the parameter value is larger than the threshold value Th, it is determined that there is a possibility of step-out, whereas it is determined that the operation is in a normal state if the parameter value is less than the threshold value Th. However, there is a possibility that the parameter may instantaneously exceed the threshold value Th due to effects of noise. Therefore, in this embodiment, in order to prevent erroneous determination owing to such cause, it is determined that there is step-out only when a state where a parameter exceeding the threshold value Th continues for a predetermined duration.

This determination is conducted using a variable td that represents the duration. If the parameter is larger than the threshold value Th in step S45, the variable td is increased by Δt (step S46). Δt represents the duration between the previous execution of the step-out determination processing routine and the present execution. Ordinarily, the step-out determination processing routine is periodically executed for a predetermined interval. In such a case, a predetermined value corresponding to this sampling time may be used as Δt. When this gradually increasing variable td exceeds a predetermined critical value tlim, it is determined that there is step-out, and the detection flag Fr is set to ON, that is, set to a value of 1 (steps S47 and 48). While the value of the variable td is equal to or less than the critical value tlim, it is determined that there is no step-out, and the detection flag Fr is set to OFF, that is, set to a value of 0 (step S50). On the other hand, if the parameter is equal to or less than the threshold value Th in step S45, it is determined that there is no step-out, and the variable td is reset to the value 0 (step S49), while the detection flag Fr is set to a value 0 (step S50).

According to a motor control unit of this embodiment as described above, it is possible to detect the presence/absence of step-out based on the deviation between the expected power to be output and the actual electric power consumption. Since the two values can easily be obtained by multiplication or addition as described above, step-out detection can be realized with an extremely low processing load. As a result, the reliability of drive control of the motor is improved. Further, when controlling the motor by detecting the electrical angle without a sensor, control becomes extremely unstable when the detection error becomes large, which makes it difficult to naturally restore the motor to a normal operation state. Accordingly, it is essential to provide step-out determination processing to ensure reliability. Step-out determination processing is extremely useful, especially if the step-out determination can be carried out with a low load as in the case with this embodiment.

In this embodiment, the result from step-out detection is only stored in the flag Fr, and no special treatment is carried out therefor. If step-out occurs, it may be dealt with by a routine located on a higher hierarchical level than the motor control processing shown in FIG. 3. There are may possible modes for the processing content, for example, the control may be such that the operation control of the motor 40 is once reset, then re-executed from a special routine for initial detection of the electrical angle. In the case of a device equipped with a power source that serves as an alternate for the motor 40, operation of the motor 40 may be stopped, and operation switched to the alternate power source. These procedures, of course, may be conducted at the same time with the step-out detection processing.

F: Modified Example of the First Embodiment;

In the embodiment, a case using the deviation between the electric power consumption Pe and the expected power Pm as a parameter for step-out determination was exemplified. There are other various possible settings for the parameter. As a modified example, a case where a parameter including a ratio of the electric power consumption Pe and the expected power Pm is used will be exemplified.

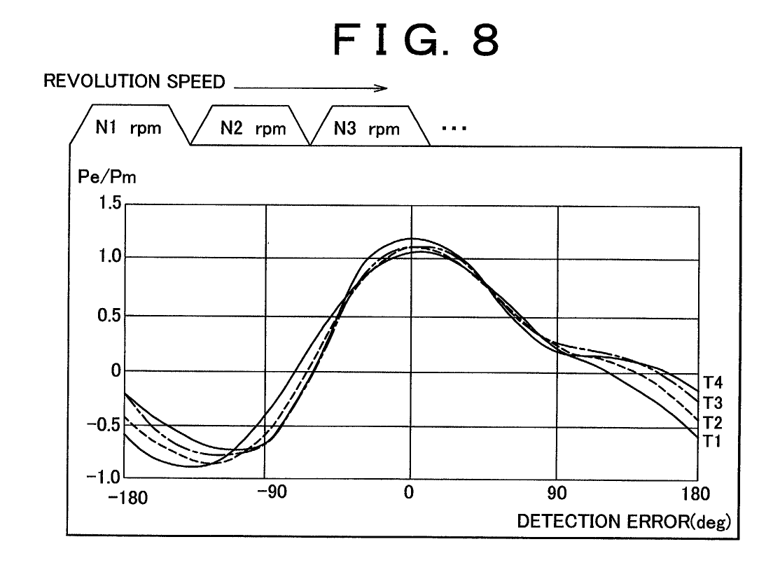

FIG. 8 is a graph showing the relationship between a parameter “Pe/Pm” and the detection error of the electrical angle. As shown earlier in FIG. 7, results for four stages of torque command values T1, T2, T3, and T4 are shown. As shown in the figure, when the detection error of the electrical angle is near 0, the ratio of the two is substantially near 1. As the detection error becomes larger, the ratio of the two becomes smaller than a value of 1. When the parameter is “Pe−Pm” in the embodiment, the results were such that the detection error and the parameter value differ according to the torque command value. On the other hand, in the modified example, as long as the detection error is within ±90 degrees, the relationship between the detection error and the parameter is the same regardless of the torque command value. Accordingly, when using the parameter “Pe/Pm” in the modified example, a threshold value that serves as a reference for step-out determination (see step S45 in FIG. 6) is independent of the torque command value, and can be set as a function of revolution speed alone.

In other words, when conducting step-out determination using the parameter “Pe/Pm” in the modified example, the parameter value which serves as a reference for step-out determination needs only to be stored as a one dimensional table in accordance with the revolution speed. The process used in the embodiment (see FIG. 6) may be directly applied for step-out determination, while obtaining the threshold value Th from the relation between the revolution speed alone in step S45. Consequently, the capacity of the table for storing the threshold value can be kept down, and there is an advantage of further simplifying the processing for obtaining the threshold value by means of interpolation or the like. Here, a case where “Pe/Pm” is used as a parameter has been exemplified, but the parameters are not limited thereto, and polynomials or the like including “Pe/Pm” may be used as the parameter.

G: Second Embodiment;

Next, a motor control unit as a second embodiment will be described. The hardware structure of the motor control unit and the content of motor control processing are the same as with the first embodiment (see FIG. 1 and FIG. 3). In the second embodiment, the content of step-out determination processing routine, that is, the type of parameter used in the processing, differs from that of the first embodiment. In the first embodiment, step-out was determined using the electrical power actually consumed by the motor 40 and the expected power to be output from the motor 40. On the other hand, in the second embodiment, the predicted value of electrical power consumption instead of the expected power, that is, the electrical power value that is expected to be consumed when the motor 40 is under normal operation is used to detect step-out. As described before, when the motor is under normal operation, the expected power of the motor 40 and the predicted value of the electrical power consumption is generally the same physical quantity. Therefore, the fundamental concept for step-out determination is the same as that in the first embodiment.

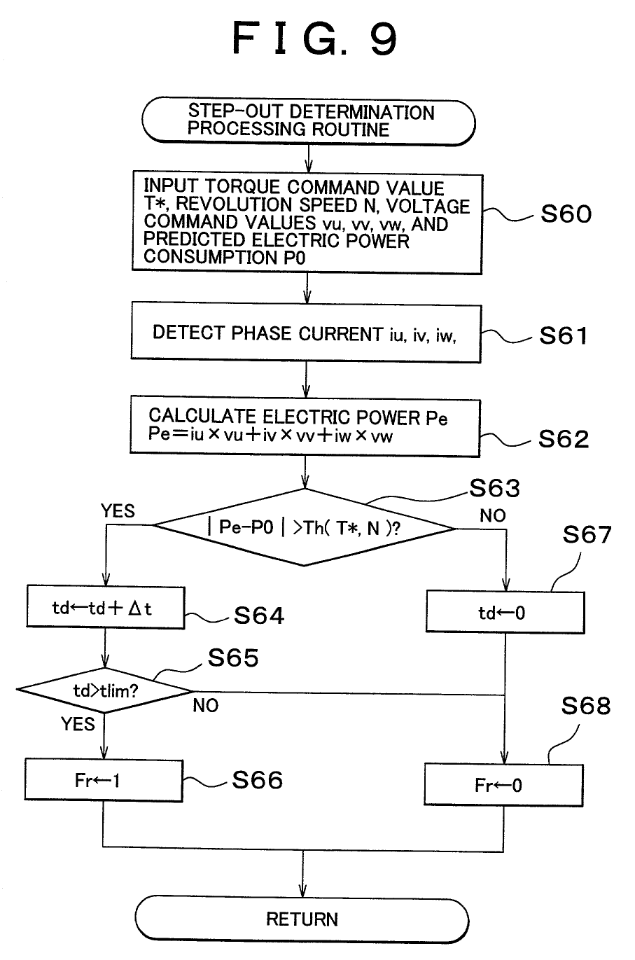

FIG. 9 is a flowchart of step-out determination processing routine in the second embodiment. In this process, the CPU 120 inputs a predicted electric power consumption P0 in addition to a torque command value T*, revolution speed N of the motor 40, and voltage command values vu, vv, and vw of the respective phases are input (step S60). The predicted electric power consumption P0 can be easily obtained by current control processing (step S30 in FIG. 3) of the motor 40. As described earlier, in electric current control, a predetermined table for the d-axis current and the q-axis current is referenced to set the d-axis current id0 and the q-axis current iq0 in accordance with the torque command value T* and the revolution speed N. To realize this current value, a d-axis voltage vd0 and a q-axis voltage vq0, and the voltage to be applied to the respective phases are calculated. If the voltage set here is applied, the above-mentioned d-axis current id0 and the q-axis current iq0 should run through their respective phases. Consequently, the predicted electric power consumption P0, in the course of current control processing, can be expressed by the following equation, using the predetermined d-axis current id0, the q-axis current iq0, the d-axis voltage vd0, and the q-axis voltage vq0.

P0=id0·vd0+iq0·vq0;

In this embodiment, the predicted electric power consumption P0 is calculated beforehand, and a table providing the predicted electric power consumption P0 together with a table providing the d-axis current and the q-axis current in accordance with the torque command value T* and the revolution speed N were prepared. In electric current control processing, the d-axis current and the q-axis current can be set while the predicted electric power consumption P0 can be obtained by referencing this table. In the step-out determination processing routine, this predicted electric power consumption P0 is input. Further, the predicted electric power consumption P0 may be calculated each time using the above-mentioned equation instead of using the table.

In the step-out determination processing routine, next, the current in the respective phases are detected (step S61), and a product of the detected current and the input voltage command value is taken to calculate the electric power Pe actually consumed (step S62). This process is similar to that in the first embodiment.

In the second embodiment, an absolute value of the deviation of the electric power consumption Pe from the predicted electric power consumption P0 is used as the parameter for step-out determination. That is, |Pe−P0| is used as the parameter. No step-out is judged to have occurred in a state where this parameter becomes larger than a predetermined threshold value Th until this state exceeds a predetermined duration tlim, and the flag Fr is maintained at a value of 0. If this state continues for the predetermined duration tlim, it is judged that step-out has occurred, and the flag Fr is set to a value of 1 (steps S63 to S66). If the above-mentioned parameter is under the threshold value Th, it is determined that step-out has not occurred, and the variable td representing the duration is reset to 0, and the flag Fr is maintained at 0 (steps S63, S67, and S68). This process is the same as that in the first embodiment.

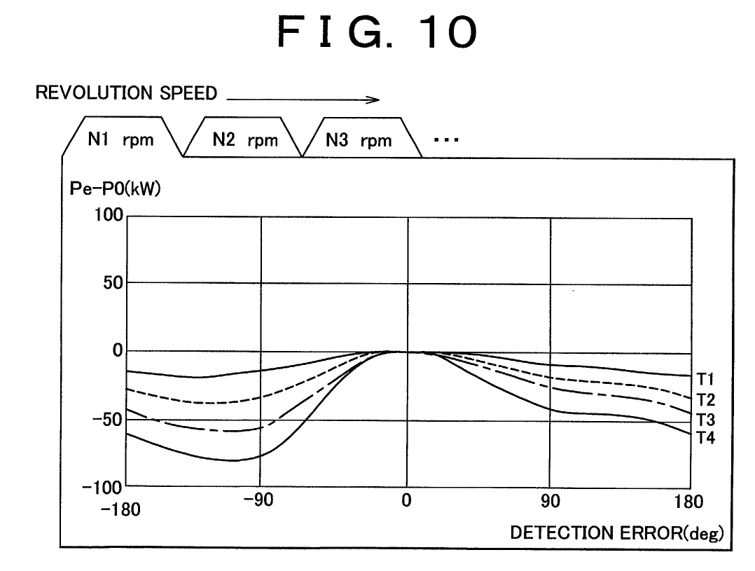

The relationship between the parameter and the threshold value Th in the second embodiment will now be described. FIG. 10 is a graph showing the relationship between “Pe−P0” and the detection error of the electrical angle. Values corresponding to four stages of torque command values T1, T2, T3, and T4 are shown. As shown in the figure, when the detection error is 0 degree, the electric power consumption Pe and the predicted electric power consumption P0 are generally the same, so that the value of “Pe−P0” becomes 0. As the detection error becomes larger, the value of “Pe−P0” deviates from 0. However, the amount of deviation of the parameter differs according to the torque command value. Also, it differs according to the revolution speed. Therefore, in the second embodiment, as with the first embodiment, the threshold value Th was set as a two dimensional table of the torque command value and the revolution speed. In step S63, the threshold value Th is obtained by referencing this two dimensional table based on the input torque command value and the revolution speed, and a relative size of this value and the parameter |Pe−P0| are compared.

According to the motor control unit of the second embodiment as described above, similar to the first embodiment, step-out can be accurately determined with a relatively light load. In the first embodiment, the expected power is calculated in the step-out determination processing, whereas in the second embodiment, the predicted electric power consumption is given by a table, which further reduces the load of step-out determination processing. Further, the synchronous motor 40 can supply the rotation axis with torque even when it is stopped. In such case, determination of step-out is difficult with the first embodiment since the expected power becomes 0, but step-out determination can be carried out without any problem with the second embodiment wherein the expected electric power consumption P0 is used.

H: Modified Example of the Second Embodiment;

In the second embodiment, a case where the deviation of the electric power consumption Pe from the predicted electric power consumption P0 is used as a parameter for step-out determination was exemplified. In the second embodiment as well, the parameters can be set with a variety of other possibilities. As a modified example, a case where a ratio of the electric power consumption Pe and the predicted electric power consumption P0 is used as a parameter will be exemplified.

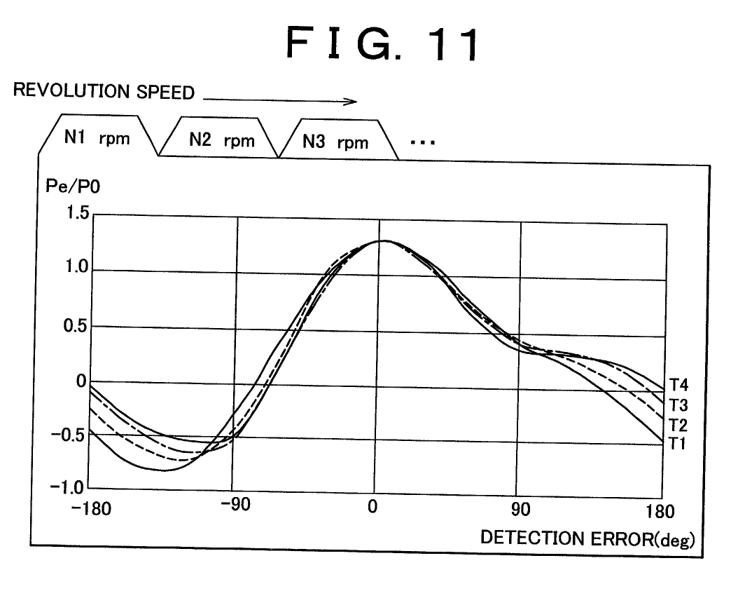

FIG. 11 is a graph showing the relationship between the parameter “Pe/P0” and the detection error of the electrical angle. The results for four stages of torque command values T1, T2, T3, and T4 are shown. As shown in the figure, when the detection error of the electrical angle is near 0, the ratio of the two becomes slightly larger than 1. As the detection error becomes larger, the ratio of the two becomes smaller. In the case with the parameter “Pe−P0” in the second embodiment, the detection error and the parameter value differed according to the torque command value. Whereas, in the modified example, as long as the detection error is within the range of ±90 degrees, the detection error and the parameter coincide regardless of the torque command value. Therefore, when using the parameter “Pe/P0” in the modified example, the threshold value that serves as the reference for determination of step-out (see step S63 in FIG. 9), does not depend on the torque command value. Consequently, the threshold value may be set as a function of the revolution speed alone.

Accordingly, when using the parameter “Pe/P0” in the modified example for step-out determination, the parameter value that serves as the reference for step-out determination needs only to be stored as a one dimensional table according to the revolution speed. The processing in the embodiment (see FIG. 6) can be applied as is for step-out determination, while the threshold value Th is determined from the relationship between the revolution speed alone in step S63. As a result, in the modified example, the capacity of the table for storing the threshold value can be kept down, and there is an advantage that the process for obtaining the threshold value by means of interpolation or the like can further be simplified. Here, a case where “Pe/P0” is used as the parameter has been exemplified. However, parameters are not limited to this, and any random parameter such as a polynomial including “Pe/P0” may be used.

The embodiments and modified examples described above address cases where the motor 40 is controlled without a sensor. The invention is applicable not only to such a case, but also to cases where there is provided a sensor for detecting the electrical angle of the motor 40. In this case, the electrical angle detection processing in the control processing of the motor (FIG. 3) is simply changed to processing for inputting the sensor output. The contents of processing for embodiments and modified examples may be applied as is to other processing including step-out determination processing. Further, the detection method for step-out as exemplified in the embodiments and modified examples may be used as a method for determining the size of detection error of the electrical angle. Furthermore, it is possible to conduct correction of the sensorless control of the motor. Correction is not limited to quantitative correction of the electrical angle, but may be such that the model or the gain of the sensorless control is switched so as to realize a control model that is more robust, when it is determined that the detection error has become larger than a predetermined value. Also, it is applicable to various corrections for realizing stable operation. Further, the embodiments and the modified examples may be used not only for detection of step-out, but also used in combination with processing for informing an operator of a device equipped with this motor that the motor is in a step-out state, or used together with processing for inhibiting or decelerating motor operation depending on the degree of step-out. An example of the latter includes, processing for inhibiting operation of the motor when it is determined that step-out is so severe such that restoration from the step-out state is impossible with normal control.

Various embodiments of the invention has been described above. However, the invention is not limited to these embodiments, and it goes without saying that various configurations may be adopted within the scope of the spirit of the invention. For example, the above-mentioned control processing may be realized with software or with hardware.

What is claimed is:

1. A step-out detection device for detecting step-out when controlling driving of a synchronous motor by detecting an electrical angle and supplying multi-phase alternating current in accordance with the electrical angle, comprising:
predicted value specifying device that obtains a predicted value of at least either an energy input to or the energy output from the synchronous motor per unit time; electric power consumption detector that detects electric power consumed by the synchronous motor; and
step-out determination device that determines whether or not the synchronous motor is in a state of step-out by comparing a relative size of a predetermined parameter derived from a deviation of the predicted value from the detected electric power with a predetermined threshold value in accordance with an operation state of the synchronous motor.

2. A step-out detection device according to claim 1, wherein the step-out determination device that determines whether or not the synchronous motor is in a state of step-out in accordance with a torque command value and a revolution speed of the synchronous motor.

3. A step-out detection device according to claim 2, wherein the predicted value specifying device obtains mechanical power input to or output from the synchronous motor based on the torque command value and the revolution speed of the synchronous motor.

4. A step-out detection device according to claim 2, wherein the predicted value specifying device obtains a predicted value of electric power to be consumed by the synchronous motor when the electrical angle is a true value based on the torque command value and the revolution speed of the synchronous motor.

5. A step-out detection device according to claim 1, wherein the detection of the electrical angle in driving of the synchronous motor is conducted without a sensor.

6. A step-out detection device for detecting step-out when controlling driving of a synchronous motor by detecting an electrical angle and applying a multi-phase alternating current to a coil in accordance with the electrical angle, comprising:
predicted value specifying device that obtains a predicted value of at least either an energy input to or an energy output from the synchronous motor per unit time;
electric power consumption detector that detects electric power consumed by the synchronous motor; and
step-out determination device that determines whether or not the synchronous motor is in a state of step-out by comparing a relative size of a predetermined parameter derived from a ratio of the predicted value and the detected electric power with a predetermined threshold value in accordance with a revolution speed of the synchronous motor.

7. A step-out detection device according to claim 6, wherein the predicted value specifying device obtains mechanical power input to or output from the synchronous motor based on a command value and a revolution speed of the synchronous motor.

8. A step-out detection device according to claim 6, wherein the predicted value specifying device obtains a predicted value of the electric power consumed by the synchronous motor when the electrical angle is a true value based on the torque command value and the revolution speed of the synchronous motor.

9. The step-out detection device according to claim 6, wherein the detection of the electrical angle is conducted without a sensor in the driving of the synchronous motor.

10. A step-out detection method for detecting step-out when controlling driving of a synchronous motor by detecting an electrical angle and applying a multi-phase alternating current to a coil in accordance with the electrical angle, comprising the steps of:
(a) obtaining a predicted value of at least either an energy input to or an energy output from the synchronous motor per unit time;
(b) detecting electric power consumed by the synchronous motor; and
(c) a step for determining whether or not the synchronous motor is in a state of step-out by comparing a relative size of a predetermined parameter derived from a deviation of the predicted value from the detected electric power with a predetermined threshold value in accordance with an operation state of the synchronous motor.

11. A step-out detection method according to claim 10, wherein the step for determining whether or not the synchronous motor is in a state of step-out in accordance with a torque command value and a revolution speed of the synchronous motor.

12. A step-out detection method for detecting step-out when controlling driving of a synchronous motor by detecting an electrical angle and applying a multi-phase alternating current to a coil according to the electrical angle, comprising the steps of:
(a) obtaining a predicted value of at least either an energy input to or an energy output from the synchronous motor per unit time;
(b) detecting electric power consumed by the synchronous motor; and
(c) determining whether or not the synchronous motor is in a state of step-out by comparing a relative size of a predetermined parameter derived from a ratio of the predicted value and the detected electric power with a predetermined threshold value in accordance with a revolution speed of the synchronous motor.
